(19) United States
(12) Patent Application Publication
(10) Pub. No.: US 2021/0343077 A1
(43) Pub. Date: Nov. 4, 2021

(54) DETERMINE SAMPLE POINTS ON SLICES FROM NURBS MODELS

(71) Applicants: UNIVERSIDADE FEDERAL DE PERNAMBUCO, Recife (BR); HEWLETT-PACKARD DEVELOPMENT COMPANY, L.P., Spring, TX (US)

(72) Inventors: Silvio De Barros Melo, Recife (BR); Francisco Paulo Magalhaes Simoes, Recife (BR); Diogo Brandao Borborema Henriques, Recife (BR); Veronica Teichrieb, Caxanga (BR); Joao Marcelo Xavier Natario Teixeira, Recife (BR); Walter Franklin Marques Correia, Recife (BR); Gutenberg Xavier da Silva Barros, Recife (BR); Marcelo Riss, Porto Alegre (BR); Scott White, Boise, ID (US)

(21) Appl. No.: 16/606,470

(22) PCT Filed: Jan. 31, 2018
(86) PCT No.: PCT/US2018/016263

§ 371 Date: Oct. 18, 2019

(51) Int. Cl. G06T 17/10; G06T 15/30

(52) U.S. Cl. CPC G06T 17/10; G06T 15/30

(57) ABSTRACT

According to examples, an apparatus may include a processor and a memory on which is stored machine readable instructions executable by the processor to: identify a slice height for direct slicing of a Non-Uniform Rational B-Spline (NURBS) model formed of surfaces by slicing planes. The instructions may cause the processor to slice the NURBS model to produce slices having the identified slice height and to adaptively sub-divide surfaces of the NURBS model whose bounding boxes respectively intersect at least one of the slicing planes until the bounding boxes meet a predefined criterion. In addition, for each of the generated bounding boxes which meet the predefined criterion, the instructions may further cause the processor to determine sample points of the surface with which the bounding box corresponds and to store the sample points of the surfaces for printing.

### BACKGROUND

Three dimensional (3D) model processing for additive manufacturing and rapid prototyping may use a Non Uniform Rational B-Spline (NURBS) model. A NURBS model may be a mathematical model used in computer graphics to generate and represent curves and surfaces of a computer generated object. For instance, NURBS models may be used in computer aided design, computer aided manufacturing, or other 3D modeling and animation programs. Surfaces of NURBS models may typically be functions of two parameters mapping to a surface in 3D space. The shapes of the surfaces may directly be determined by the positioning of the control points of the surfaces and weights and this relation may be described parametrically through the use of rational functions. This kind of modeling may represent various types of geometrical shapes from simple geometrical shapes, such as triangles and quadrics all the way to high-degree free form surfaces.

### BRIEF DESCRIPTION OF THE DRAWINGS

Features of the present disclosure are illustrated by way of example and not limited in the following figure(s), in which like numerals indicate like elements, in which:

FIG. 1 shows an example apparatus that may perform direct slicing of a NURBS model;

FIGS. 2 and 3, respectively, show flow diagrams of example methods for direct slicing of a NURBS model;

FIGS. 4A-4H, respectively, show flow diagrams of example methods for direct slicing of an example of a NURBS model; and

FIG. 5 shows an example of a NURBS model that was directly sliced through implementation of the example methods depicted in FIGS. 2 and 3.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

A challenge in three dimensional (3D) printing processes may arise from scenarios in which 3D printing systems are distributed over local and/or global networks and models and printing files are to be shared over these networks. In these scenarios, the sizes of the models and printing files may be a bottleneck on the network. For instance, when converting a 3D model of an object, such as a NURBS model, to a tessellated mesh for slicing and printing using a traditional pipeline, the converted mesh may not be memory-friendly and even a simple object may reach many megabytes in size.

Another issue in mesh generation may be that the generated mesh in a traditional pipeline (traditional flat triangles mesh-based representation) may also be unable to adjust the 3D model outside of the 3D model producer. As a result, the generated mesh may not be able to deal with many processes. For instance, scale changes may not be performed without precision loss or may not improve a NURBS approximation by sampling more points on the slice.

The apparatuses and methods disclosed herein may overcome or reduce the issues discussed above by slicing NURBS models without relying on the tessellation approximation or any other approximation of the surface except for the approximations imposed by a precision of a 3D printing system. In addition, the apparatuses and methods disclosed herein may produce more accurate versions of the NURBS models because approximations of the NURBS models may be based on interpolated curves generated from sampled surface points rather than on approximations of curves using other shapes such as meshes or triangles. Moreover, the versions of the NURBS models generated through implementation of the apparatuses and methods disclosed herein may consume less memory because, instead of storing three coordinates for each flat triangle vertex, for a large number of triangles, the method may store a reduced number of control points and weights.

According to examples, disclosed herein are apparatuses and methods for adaptively determining sample points of a non-uniform rational B-spline (NURBS) model of an object, arranged in layers. Particularly, for a given NURBS model of an object (which is also referenced herein as a NURBS model), a slice height for direct slicing of the NURBS model may be identified. Although the slice height may be any suitable slice height, in some examples, the slice height may be equivalent to the height of a layer of printing material that a 3D printing system may apply during successive printing operations to form an object. By way of example, the slice height may be a height ranging from about 0.1 mm to about 1 mm.

The NURBS model may be sliced to produce slices having the identified slice height along a horizontal direction. The slicing operation may determine a set of curves, in which each of the curves is the intersection between a slicing plane and a surface of the NURBS model object. The slicing plane may be parallel to a printing bay of a 3D printing system and may contain a certain number of sampled points from an intersecting curve. The certain number of sampled points may directly be proportional to a desired precision level, e.g., the maximum distance between consecutive sampled points. As a result, the number of sampled points may affect the quality of an object printed from the sampled points.

Generally speaking, the apparatuses and methods disclosed herein may employ three major phases to directly slice a NURBS model. The three major phases may be identified as an initialization phase, an adaptive subdivision phase, and a slice generation phase. In the initialization phase, a projective version of the NURBS model is generated, which is a regular polynomial B-spline surface in projective space. The projective NURBS model provides properties that are needed to effectively slice NURBS objects, such as the separability or tensorial property of B-Spline Models. For example, the disclosed method may slice the NURBS model in projective space by continuously subdividing the surface of the NURBS model through a curve-based (tensorial) subdivision algorithm. The disclosed method may use the mathematical modeling of the projective 3D model to properly calculate the slices. A first bounding box for the NURBS model may also be identified during the initialization phase.

In the adaptive subdivision phase, the intersections between the surface of the NURBS model and slicing planes may be determined through adaptive subdivision of the NURBS surface recursively into smaller patches. The subdivision may be carried out by a curve-based subdivision algorithm that may be applied to the rows of the control points first, followed by application of the algorithm on the columns of the control points, or alternatively, to the columns of the control points first, followed by the rows. This procedure may produce the control points of the patches that may then be used to compute the bounding boxes of the patches. According to examples, the intersections may be determined in parallel to reduce computation time. In the slice generation phase, from the adaptively subdivided patches whose bounding boxes met a stop criterion, sampled points on the surface of the NURBS model belonging to particular slices may be computed and organized in sequence from which a final parametric curve may be produced. In addition, the final parametric curve may be mapped from projective space to Euclidean space or, alternatively, the sampled points may be individually mapped into the Euclidean space and then the final parametric curve may be inferred.

By way of particular example, the apparatuses and methods disclosed herein may apply an adaptive subdivision of NURBS model surfaces consecutively until their computed bounding boxes meet a precision criterion. That is, bounding boxes of continually smaller sizes for the NURBS model surfaces may be generated until the bounding boxes meet the precision criterion. The bounding boxes may meet the precision criterion when the bounding boxes (which contain a portion of the NURBS model surface) intersect at least one plane and have sufficiently small dimensions that meet predefined dimensions. For the bounding boxes that meet the precision criterion, a point may be sampled. In an example, a centroid of the bounding box may be used to represent a sampled point on the surface of the NURBS model. The disclosed apparatuses and methods may then aggregate the sampled points either as a polygon or as curves to form an accurate version of the NURBS model that a 3D printing system may use to print an object.

In examples, the apparatuses and methods disclosed herein may aggregate the sampled points by connecting the sampled points for one layer (2D shape), which may be printed by 3D printing systems. In other examples, the apparatuses and methods disclosed herein may use the sampled points to infer a parametric curve with control points that may be used to draw the curves belonging to the surface of the NURBS model. Processing of the points and generating the curves may be implemented outside of a 3D printing system, but the 3D printing system may interpret the curves.

Through implementation of the apparatuses and methods disclosed herein, NURBS models may directly be sliced within a parametric 3D printing pipeline. As a result, the NURBS models may directly be sliced while achieving at least as good as or improved precision on traditional 3D printing pipelines regardless of the NURBS model geometry and topology, reducing model and 3D printing file sizes in disk/network for the general case of objects containing at least one curved surface, maintaining parametric information natively throughout the printing pipeline, maintaining precision regardless of object scale, making NURBS slicing process feasible and scalable (covering all curves randomness/complexity present in any ordinary part) in a software implementation stand point, or the like.

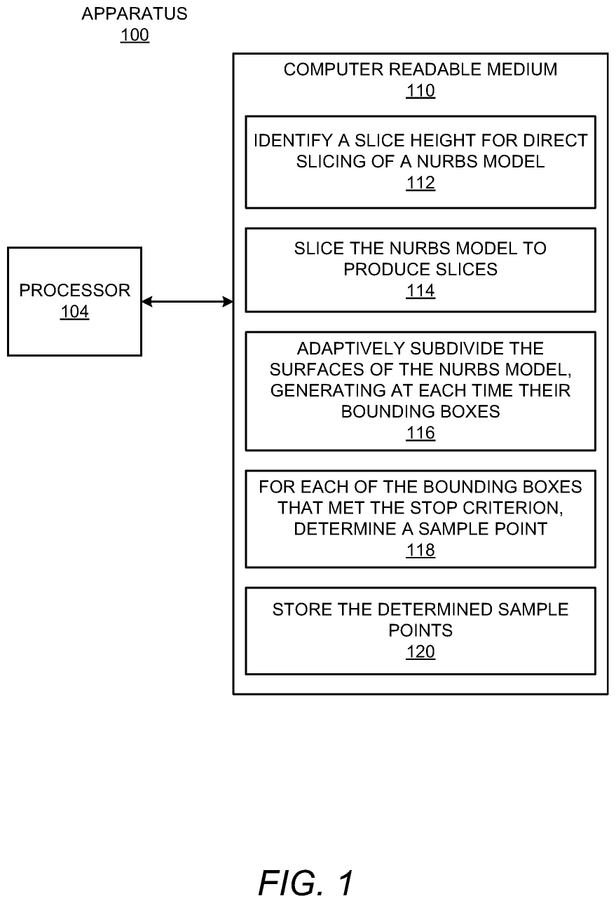

FIG. 1 shows an example apparatus that may perform direct slicing of a NURBS model. It should be understood that the apparatus 100 may include additional components and that some of the components described herein may be removed and/or modified without departing from a scope of the apparatus 100 disclosed herein.

The apparatus 100 may be a computing device, a tablet computer, a server computer, a smartphone, or the like, and may include a processor 104, which may be a semiconductor-based microprocessor, a central processing unit (CPU), an application specific integrated circuit (ASIC), a field-programmable gate array (FPGA), and/or another hardware device. Although a single processor 104 is depicted, it should be understood that the apparatus 100 may include multiple processors, multiple cores, or the like, without departing from a scope of the apparatus 100.

The apparatus 100 may also include a non-transitory computer readable medium 110 that may have stored thereon machine-readable instructions 112-120 executable by the processor 104. Examples of the non-transitory computer readable medium 110 may include an electronic, magnetic, optical, or other physical storage device that contains or stores executable instructions. For example, the non-transitory computer readable medium 110 may be a Random Access memory (RAM), an Electrically Erasable Programmable Read-Only Memory (EEPROM), a hard disk, an optical disc, or other type of storage device.

The processor 104 may fetch, decode, and execute the machine-readable instructions 112 to identify a slice height for direct slicing of a Non-Uniform Rational B-Spline (NURBS) model formed of surfaces by slicing planes of any given orientation. According to examples, the slice height may be equivalent to the thickness of a layer of a printing material to be used by a 3D printing system in printing the NURBS model. That is, the slice height may be equivalent to a height of each of the layers of printing material that a 3D printing system applies during an object printing operation. In other examples, the slice height may be a user-defined height, a height corresponding to another feature, or the like.

The processor 104 may fetch, decode, and execute the machine-readable instructions 114 to slice the NURBS model to produce slices, in which each of the slices has the identified slice height. In examples, some or all of the slicing planes used to intersect with the NURBS model may lie between respective pairs of the produced slices. Equivalently, some or all of the slices of the NURBS model may lie between respective pairs of the slicing planes.

The processor 104 may fetch, decode, and execute the machine-readable instructions 116 to adaptively subdivide the surfaces of the NURBS model (which may be based on an algorithm that works on the control points of the surfaces of the NURBS model) that intersect at least one of the slicing planes and meets a predefined criterion. In addition, a corresponding bounding box may be generated at each time that the surfaces are subdivided. A bounding box may be defined as a box canonically oriented that minimally bounds the control points of at least a portion of the NURBS model, e.g., a portion of a surface of the NURBS model. In this regard, a larger bounding box may contain a larger portion of the surface. As discussed herein, smaller and smaller bounding boxes may be generated through adaptively subdividing the NURBS model surface's control points until the respective bounding box meets the predefined criterion. Particularly, larger surfaces may be split into patches, and each of the patches may further be split into sub-patches and so forth until the bounding boxes built from the control points of the patches that intersect at least one of the slicing planes, meet the predefined stop criterion.

In examples, the predefined criterion may pertain to a predefined size, such that the bounding box may be determined to meet the predefined size when a largest dimension of the bounding box meets the predefined size. For instance, the predefined size may be equivalent to the slice height. As other examples, the predefined size may be smaller than the slice height, may correspond to another user-defined size, may correspond to a 3D printing system printing property, a printing material to be used to fabricate the NURBS model, or the like.

The processor 104 may fetch, decode, and execute the machine-readable instructions 118 to, for each of the generated bounding boxes that respectively intersect at least one of the slicing planes and meet a predefined stop criterion, determine a sample point of the surface inside the bounding box. Any arbitrarily chosen point inside the bounding box may correspond to a single point on the surface of the NURBS model. That is, for instance, as the predefined criterion may be a relatively small value, a bounding box that meets the predefined criterion may also be relatively small. In this regard, any point in the interior of the bounding box that meets the predefined criterion may be considered a point on the surface of the NURBS model, up to that predefined criterion. In particular, the centroid of the bounding box may be construed as corresponding to the sampled point of the NURBS model surface.

By tracking the relative locations of the bounding boxes that met the stop criterion with respect to each other and/or another reference position, the shapes of the slicing curves of the NURBS model may be identified. The processor 104 may fetch, decode, and execute the machine-readable instructions 120 to store the determined sample points ordered in such a way that the interconnection of the sample points may provide the correct shape of the slicing curve. The so determined sample points may correspond to a slice of the NURBS model and may be used for printing the NURBS model.

According to examples, the processor 104, which may include multiple processors and/or multiple cores, may adaptively subdivide and generate multiple control points of the patches and their bounding boxes in parallel. In addition, the processor 104 may track the bounding boxes to ensure that the bounding boxes are not processed more than once. As such, for instance, the processor 104 may perform the adaptive subdivision and generation of the control points of the patches and the bounding boxes corresponding to the patches in a relatively quick and efficient manner.

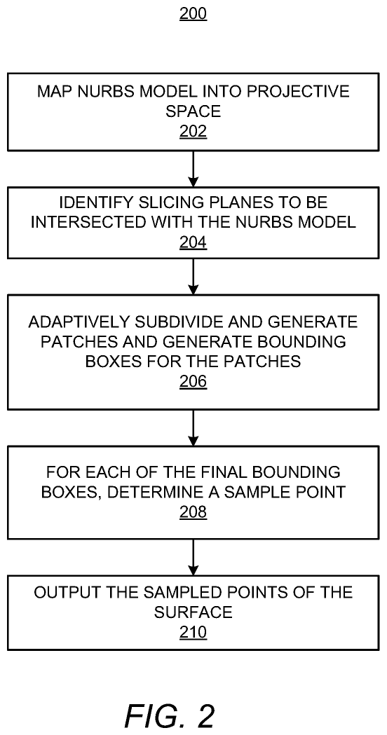

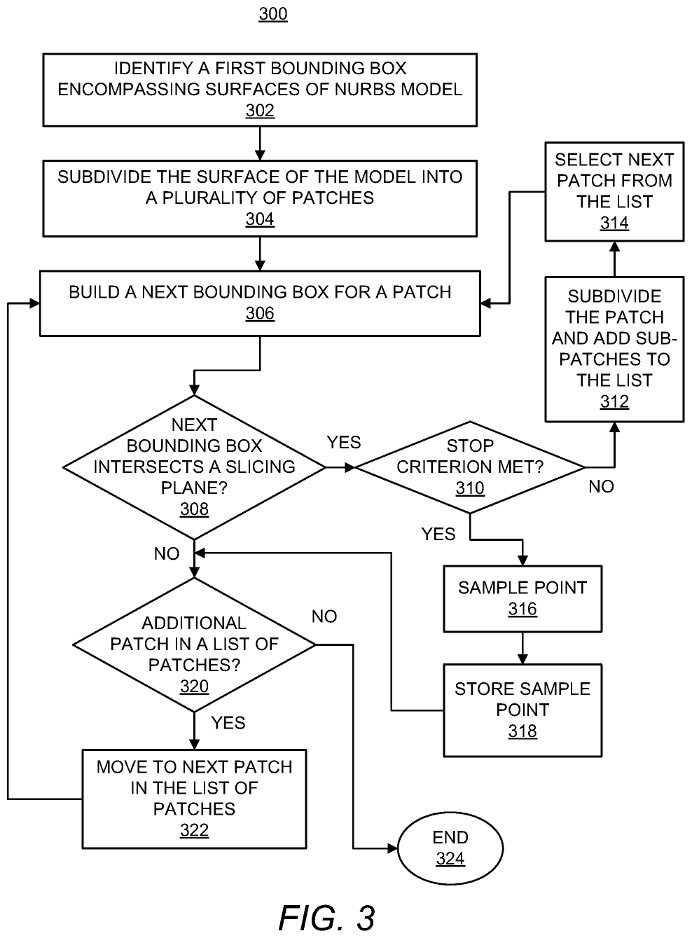

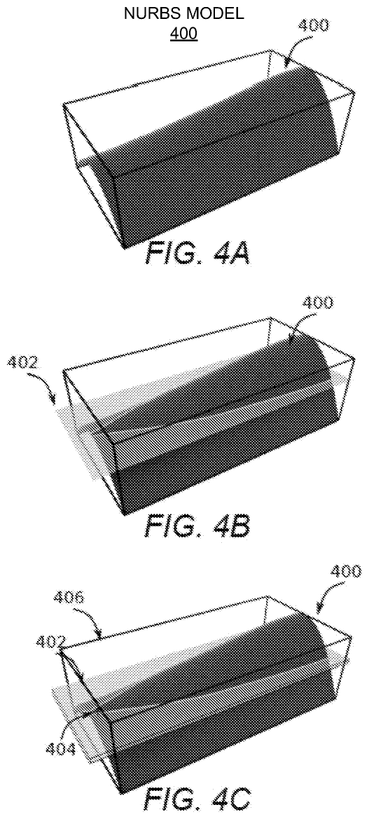

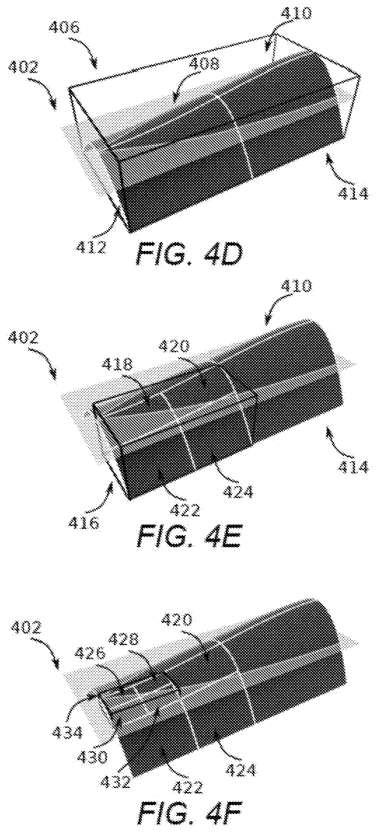

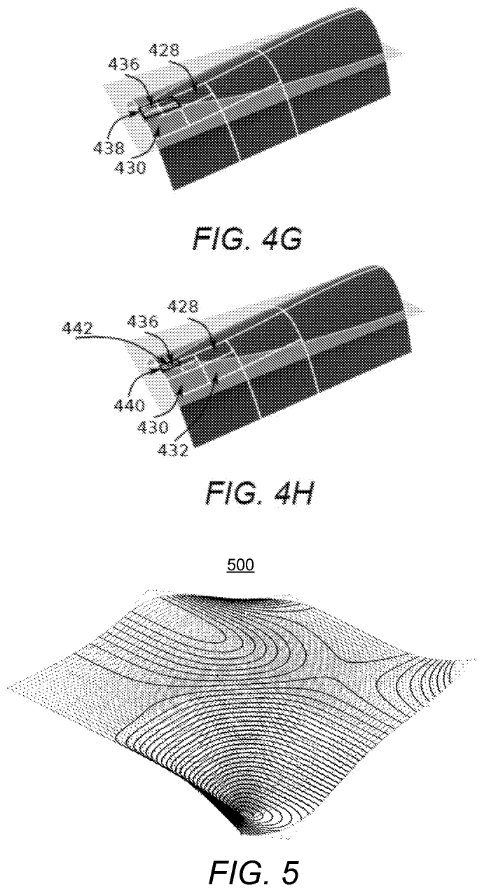

Turning now to FIGS. 2 and 3, there are respectively shown flow diagrams of example methods for direct slicing of a NURBS model. It should be understood that the methods 200 and 300 depicted in FIGS. 2 and 3 may include additional operations and that some of the operations described therein may be removed and/or modified without departing from scopes of the methods 200 and 300. The descriptions of the methods 200 and 300 are also made with reference to the features depicted in FIG. 1 for purposes of illustration. Particularly, the processor 104 of the apparatus 100 may execute some or all of the operations included in the methods 200 and 300. In the descriptions of the methods 200 and 300, reference is also made to FIGS. 4A-4H, which respectively show stages at which the bounding boxes may adaptively be generated according to an example. It should be clearly understood that the features depicted in FIGS. 4A-4H are merely examples and should not be construed as limiting the present disclosure to the features depicted in those figures.

With reference first to FIG. 2, at block 202, the processor 104 may map a surface of a NURBS model, which may be in Euclidean space, into projective space. The NURBS model may be a 3D model of an object. The projective version of the NURBS surface may be a B-spline surface (polynomial composite) in projective space. The surface of the NURBS model may be mapped to projective space through use of homogeneous coordinates, which are 4-tuples of real numbers associated to points in straight lines passing through the origin of the four-dimensional Euclidean space. Each of the straight lines may be taken as a single point in a three-dimensional space called projective space. The projective space may enable degeneracies that may appear from surfaces described with rational functions, as it is the case of NURBS, to be avoided. In rational form, whenever the denominator approaches zero, the resulting surface tends to break apart. In terms of control points, this may happen whenever some of the weights are negative while others are positive.

In the three-dimensional projective space, with the representation of the NURBS model through homogeneous coordinates, a control point with negative weight may simply be a point underneath the hyperplane w=0, the so called “plane at infinity”. If some control points are above this plane while others are underneath this plane, the resulting surface may intersect this plane at infinity and may produce discontinuities when the surface is projected back into Euclidean space. However, discontinuity may not occur provided the NURBS model is kept in projective space. In addition, a B-splines surface in any space may be separable, which may not be the case of NURBS models in the 3D-Euclidean space (rational form). That means that any algorithm designed to work with curves may work with surfaces in a tensorial fashion. According to examples, the methods disclosed herein may operate entirely in projective space and may convert back to the Euclidean space when the sampled points are ready to be output.

The representation through homogeneous coordinates may be implemented through the addition of a fourth coordinate to each 3D control point and by multiplying all of the first three coordinates of the 3D control point by an associated weight of the 3D control point, and considering the weight itself as the fourth coordinate of the 3D control point. In other words, if:

$$p 3 D = [ \begin{matrix}x \\ y \\ z\end{matrix} ] ,$$

in homogeneous coordinates, the

$$p3D\_homog = [ \begin{matrix}w * x \\ w * y \\ w * z \\ w\end{matrix} ] ,$$

where w is the weight of the 3D control point.

At block 204, the processor 104 may identify slicing planes to be intersected with the NURBS model. FIG. 4A depicts a perspective view of a NURBS model 400. Shown in FIG. 4B is a slicing plane 402, which may be one of a plurality of parallel slicing planes (only a single slice is highlighted for clarity). As shown, some of the slices 404 abut pairs of slicing planes and are orthogonal to a vertical axis of the NURBS model 400. In addition, each of the slices 404 may have a slice height as discussed above. Thus, for instance, each of the slices 404 may have a slice height that is equivalent to a printing material layer thickness. In addition or in other examples, the slice height may be user-defined based on a desired precision of printing. Thus, for instance, the heights of the slices 404 may be higher for relatively lower precision printing and may be lower for relatively higher precision printing.

At block 206, the processor 104 may adaptively subdivide the surfaces of the NURBS model into patches and may generate control points for the patches. The processor 104 may also generate bounding boxes for the respective patches that respectively intersect at least one of the slicing planes. A more detailed description of a manner in which the processor 104 may adaptively subdivide and generate the patches' control points and their bounding boxes is discussed herein below with respect to FIG. 3.

At block 208, the processor 104 may, for each of the produced bounding boxes that respectively intersects at least one of the slicing planes and meets the predefined criterion (herein called the final bounding box), determine a sample point of the patch with which the bounding box corresponds. As discussed herein, each of the bounding boxes may include a portion (e.g., a patch) of a surface of the NURBS model 400. The sample point of the surface may be the centroid of a final bounding box or may be another point within the final bounding box as discussed herein.

At block 210, the processor 104 may output the determined sample points of the surfaces of the NURBS model. The determined sample points may correspond to a set of surface points on the surface of the NURBS model sampled on horizontal planes that divide the layers that represent the print material deposition. In addition, the processor 104 or another processing component may process the sample points to interpolate or otherwise identify polygons or curves of the surface of the NURBS model, in which the polygons or curves may be used to print an object from the NURBS model as discussed below. In some examples, the processor 104 may output the determined sample points to another computing device, a 3D printer, a data store, or the like.

Each of the sample points may be defined by a pair of parameter values that accompany the respective sample point. For instance, each of the determined sample points may include six floating point numbers: a pair of parameter values (uᵢ, vᵢ) and four coordinate values (xᵢ, yᵢ, zᵢ, wᵢ) corresponding to the sample points in the 3D projective space. A pair of parameter values may constitute a form of identifying each point on the surface of the NURBS model. One real value may be sufficient to identify each of the points of a curve, which is a 1D object. A surface is a 2D object and a sample point of the surface may be identified by two independent values. The processor 104 may project the acquired surface points into the Euclidean space by dividing each coordinate (xᵢ, yᵢ, zᵢ, wᵢ) by the fourth coordinate (wᵢ), thereby transforming the point onto the Euclidean Space defined as (xᵢ/wᵢ, yᵢ/wᵢ, zᵢ/wᵢ). The processor 104 may use a tree structure induced by a depth search for sorting of the points in each plane. The processor 104 may use the points to produce an interpolating curve representing the intersection between the surface of the NURBS model and the slicing plane. Solving the intersections in this manner may optimize memory usage.

The processor 104 may perform a traversal in a depth search to enumerate each tree leaf as the tree leaf is visited to produce a sorted sequence of surface points throughout the set of planes intersecting the NURBS model. For any given slicing plane, there may be a set of subsequences of numbers indexing adjacent points that may be sorted and concatenated. The geometric coherence held by subsequent points may be guaranteed by their common ancestry in the traversal. In one regard, guaranteeing the common ancestry of the subsequent points may solve ambiguities in the sorting and concatenation of the sample points when separate parts of the intersecting curve approach each other to near self-intersection, up to a precision threshold. Therefore, surface points may be aggregated in the same slicing plane through sorting and concatenation of subsequences of indices. The ambiguities may be resolved by considering their common ancestry in the tree structure. In addition, parametric curves that interpolate the points may be built. The guaranteed precision may be sufficient to produce parametric curves that preserve the NURBS model's features up to a predefined precision threshold.

The parametric curves may also be rational splines and the degree of each projective polynomial curve segment may be the addition of the degrees of the projective subdivided patch in each direction. The interpolating process may use the curve parameter values associated to the sampled points in order to find the control points and their weights by solving the appropriate linear system. The information identifying the end points of each curve segment may be stored. As there may be no direct relation between the degree of the intersecting curve and the slicing phase, the number of sample points may or may not be much greater than the degree of the curve. The linear system may be used to find the control points of the interpolating rational curve having 3*(n−1) degrees of freedom, where n is the degree of the interpolating curve. Considering that the end points of each curve may represent the control points, the end points may have weight 1.0. The curve is rational but planar. As a result, a minimum of n−1+(n−1)/2 points may be used to solve the linear system. The minimum number of point may be used as an additional stop criteria (e.g., predefined criterion) if the slices produce interpolating rational Bezier curves. In an example, an approximating rational Bezier curve may be determined according to the least squares criterion. In this case, there may be no additional constraints on the minimum number of surface points produced per curve segment.

Reference is now made to FIG. 3, which depicts a flow diagram of an example method 300 for adaptively subdividing the patches of the NURBS model and their the bounding boxes at block 206 in FIG. 2. Reference is also made to FIGS. 4C-4H, which respectively show stages at which the patches and their bounding boxes may be adaptively generated according to an example. According to examples, various operations included in the method 300 may be implemented in parallel to increase the speed and efficiency with which the patches may adaptively be subdivided and the sample points may be determined.

At block 302, the processor 104 may identify a first bounding box 406 that encompasses the surfaces of the NURBS model 400. The dimensions of the first bounding box 406 may be selected based on the control points of the NURBS model. In other words, the first bounding box 406 may have each of its dimensions to be large enough to minimally encompass the NURBS model.

At block 304, the processor 104 may subdivide the surface of the NURBS model 400 inside the first bounding box 406 into a plurality of patches 408-414. For example, the processor 104 may use the extended De Boor's sub-division algorithm that subdivides the first bounding box 406 into four patches 408-414. In other examples, the processor 104 may use another sub-division algorithm to subdivide the first bounding box 406 into two or more patches. In any regard, the processor 104 may store the patches 408-414 in a list, e.g., a list that identifies the patches 408-414.

According to an example, the processor 104 may apply de Boor's Knot Insertion Algorithm for B-spline curves extended to subdivide the surfaces. In this example, de Boor's Knot Insertion Algorithm for B-spline curves is extended to work with surfaces with G. Farin's notation (Farin, G., Curves and Surfaces for Computer Aided Geometric Design: A Practical Guide—4th Edition—Academic Press, 1997) on page 148, generalized for NURBS surfaces through the use of its tensorial property, which may only be valid in projective space). In this example, a NURBS surface has degrees n and m, parametrized by (u, v) with knot sequences: u₀, u₁, . . . , u_{L+2n-2} and v₀, u₁, . . . , v_{P+2m-2}, where L and P determine the amount of domain intervals in u and V directions, respectively (up to the amount of multiplicities of the knots). In addition, d_{i,j}^{0,0}=(x_{i,j}, y_{i,j}, z_{i,j}) are the control points and w_{i,j} are their weights, with iϵ{0, 1, 2, . . . , L+n−1} and jϵ{0, 1, 2, . . . , P+m−1}. These points, seen in IP³ (projective space), may be written in homogeneous coordinates as follows: \tilde{d}_{i,j}^{0,0}=(x_{i,j}·w_{i,j}, y_{i,j}·w_{i,j}, z_{i,j}·w_{i,j}, w_{i,j}), for iϵ{0, 1, 2, . . . , L+n−1} and jϵ{0, 1, 2, . . . , P+m−1}.

The adaptive subdivision includes a sequence of knot insertions, producing new B-spline control points that form four sub-meshes, and each sub-mesh may be tested for intersection against the slicing plane. In the affirmative case, the sub-mesh may be subdivided and the previous phase may be repeated until a desired precision level is met. In the first subdivision the knot to be inserted is (u*, u*)=½(uₙ₋₁+u_{L+n-1}), ½(vₙ₋₁+v_{P+m-1})) Suppose the domain in which the knot (u*, v*) lies is [uₗ, uₗ₊₁]×[vⱼ, vⱼ₊₁], where lϵ{n−1, . . . , L+n−1} and Jϵ{m−1, . . . , P+m−1}. The control points produced by these insertions are computed in a tensor form:
1. For each iϵ{0, 1, 2, . . . , L+n−1}, the m insertions of knot v* produce \tilde{d}_{i,j-m+1+k}^{0,k} and \tilde{d}_{i,j+1}^{0,k} for k=0, 1, 2, . . . , m. Replace points \tilde{d}_{i,j}^{0,0} with Jϵ{J—m+2, . . . , J} by the computed points, maintaining the mesh regular connections, which respect the control points order. These actions so far subdivide the NURBS surface into two large patches (considering all iϵ{0, 1, 2, . . . , L+n−1}):
   a. the “left patch”, with control points: L\tilde{d}_{i,j}^{0,0}←\tilde{d}_{i,j}^{0,0} for j=0, 1, . . . , J−m+1, and L\tilde{d}_{i,j-m+1+k}^{0,0}∂\tilde{d}_{i,J-m+1+k}^{0,0}, for k=1, . . . , m.
   b. the “right patch”, with control points: R\tilde{d}_{i,k}^{0,0}←\tilde{d}_{i,j+1}^{0,m-k}, for k=0, 1, . . . , m−1, and R\tilde{d}_{i,k+m}^{0,0}←\tilde{d}_{i,J+1+k}^{0,0}, for k=0, 1, . . . , P+m−2−J.
2. Now a subdivision occurs in the other direction with respect to both the left and the right patches. For each jϵ{0, 1, 2, . . . , P+m−1} the n insertions of knot u* produce L\tilde{d}_{l-n+1+k,j}^{k,0} and L\tilde{d}_{l+1,j}^{k,0}, for k=1, . . . , n and j≤J+1; and R\tilde{d}_{l-n+1+k,j}^{k,0} and [symbol] _{l+1,j}^{k,0}, for k=1, . . . , n and 0≤j≤P+2−m−2−J. Replace control points L\tilde{d}_{i,j}^{0,0}, and R\tilde{d}_{i,j}^{0,0} with iϵ{l−n+2, . . . , l} by the computed points, maintaining the mesh regular connections, which respect the control points order. These actions end up subdividing each patch (left and right) into two sub-patches (considering all jϵ{0, 1, . . . , J+1} for the left patch and jϵ{0, . . . , P+2m−2−J} for the right patch).

In the left patch, we get:
a. the “patch A”, parametrized by [uₙ₋₁, u*]×[vₘ₋₁, v*], with knot sequences u₀, u₁, . . . , uₗ, u* and v₀, v₁, . . . , vⱼ, v*, where u* has multiplicity n and v* has multiplicity m having the following control points:
   A\tilde{d}_{i,j}^{0,0}← [symbol] _{i,j}^{0,0}, for i=0, 1, . . . , l−n+1, and j=0, 1, . . . , J+1.
   A\tilde{d}_{l-n+1+k,j}^{0,0}←L\tilde{d}_{l-n+1+k,j}^{k,0}, for k=1, . . . , n, and j=0, 1, . . . , J+1.
The “patch C”, parametrized by [u*, u_{L+n-1}]×[vₘ₋₁, v*], with knot sequences u*, uᵢ₊₁, . . . , u_{L+2n-2} and v₀, v₁, . . . , vⱼ, v*, where u* has multiplicity n and v* has multiplicity m having the following control points:
   C\tilde{d}_{k+n,j}^{0,0}← [symbol] _{l+1+k,j}^{0,0}, for k=0, 1, . . . , L+n−2−1, and j=0, 1, . . . , J+1.
   C\tilde{d}_{k,j}^{0,0}←Ld_{l+1,j}^{n-k,0}, for k=1, . . . , n and j=0, 1, . . . , J+1.

In the right patch, we get:
a. the “patch B”, parametrized by [uₙ₋₁, u*]×[v*, v_{P+m-1}], with knot sequences u₀, u₁, . . . , uₗ, u* and v*, v_{J+1}, . . . , v_{P+2m-2}, where u* has multiplicity n and v* has multiplicity m having the following control points:
   B\tilde{d}_{i,j}^{0,0}← [symbol] _{i,j}^{0,0}, for i=0, 1, . . . , l−n+1, and j=0, 1, . . . , P+2m−2−J.
   B\tilde{d}_{l-n+1+k,j}^{0,0}←R\tilde{d}_{l-n+1+k,j}^{k,0}, for k=1, . . . , n, and j=0, 1, . . . , P+2m−2−J.
b. The “patch D”, parametrized by [u*, u_{L+n-1}]×[v*, v_{P+m-1}], with knot sequences u*, uₗ₊₁, . . . , u_{L+2n-2} and v*, vⱼ₊₁, . . . , v_{P+2m-2}, where u* has multiplicity n and v* has multiplicity m having the following control points:
   D\tilde{d}ᵢ₋ₗ₋₁^{0,0}← [symbol] _{i,j}^{0,0}, for i=l+n+2, . . . , L+2n−l−2, and j=0, 1, . . . , J+1.
   D\tilde{d}_{k,j}^{0,0}←R\tilde{d}_{l+1,j}^{n-k,0}, for k=1, . . . , n, and j=0, 1, . . . , P+2m−2−J.

Notice that the four patches share a control point with which the control mesh clamps on the surface: A\tilde{d}_{l+1,J+1}^{0,0}=B\tilde{d}_{i+1,0}^{0,0}=C\tilde{d}_{0,J+1}^{0,0}=D\tilde{d}_{0,0}^{0,0}=\tilde{d}_{l+1,J+1}^{n,m}. Whenever the parameter space of a patch becomes a subset of a domain interval, the surface becomes a Rational Bezier (tensorial). Each patch can be seen as a different surface, with its own parameterizing rectangles, knot sequences and index bounds. Therefore a subdivision just like the one described above can be applied to them recursively.

At block 306, the processor 104 may build a next bounding box 416 (FIG. 4E) for one of the patches 412. The next bounding box 416 may include a portion of the NURBS model 400 surface. In addition, at block 308, the processor 104 may determine whether the next bounding box 416 intersects a slicing plane 402. Based on a determination that the next bounding box 416 intersects a slicing plane 402, at block 310, the processor 104 may determine whether the next bounding box 416 meets a stop criterion. The stop criterion may be a predefined criterion as discussed herein, e.g., a maximum dimension. Based on a determination that the next bounding box 416 does not meet the stop criterion at block 310, the processor 104 may subdivide the patch 412 into additional sub-patches 418-424 as shown in FIG. 4F. That is, the processor 104 may subdivide the patch 412 using a subdividing algorithm as discussed above with respect to block 304. The processor 104 may also store the sub-patches 418-424 in a list, e.g., a list that identifies the sub-patches 418-424.

At block 314, the processor 104 may select one of the sub-patches 418 that includes a portion of the NURBS model 400 surface. In addition, the processor 104 may build a next bounding box 434 (FIG. 4F) for the selected sub-patch 418. The processor 104 may also determine whether the next bounding box 434 intersects a slicing plane 402 at block 308 and may determine whether the next bounding box 434 meets the stop criterion at block 310. The processor 104 may further sub-divide the patch 418 at block 312 and may select a next sub-divided patch having a portion of the NURBS model 400 surface based on the next bounding box 434 failing to meet the stop criterion at block 310. The processor 104 may continue to sub-divide the patches until a bounding box for the sub-divided patch that includes a portion of the NURBS model 400 surface and meets the stop criterion is identified at block 310. An example of a bounding box 440 that meets the stop criterion is shown in FIG. 4H. Particularly, for instance, the bounding box 440 may include a portion of the NURBS model 400 surface and may have dimensions in which a largest dimension is smaller than a height of a slice 404 between two slicing planes 402.

In addition, at block 316, the processor 104 may determine a sampled point 442 of the bounding box 440. The sampled point 442 may correspond to an intersection of a surface of the NURBS model 400 and a slicing plane 402. In addition, the sampled point 442 may correspond to a centroid of the bounding box 440. At block 318, the processor 104 may store the sampled point 442 in a memory or data store (not shown). The processor 104 may also remove the patch (or sub-patch) from which the sampled point was determined and stored from the list of patches. The processor 104 may also remove patches or sub-patches that do not contain a portion of the NURBS model 400 surface from further processing.

With reference back to the determination at block 308 that a next bounding box does not intersect a slicing plane 402 (e.g., does not contain a portion of the NURBS model 400) or after block 318, the processor 104 may determine whether there is an additional patch in the list of patches to be processed as indicated at block 320. As discussed above, when the processor 104 subdivided the first surface into the patches 408-414, the processor 104 may have stored the patches 408-414 in a list. In addition, during a first iteration of block 306, the processor 104 may have built a bounding box for one of the patches 408 in the list. As such, based on a determination that an additional patch 410 in the list has yet to be processed, e.g., there is an additional patch in the list, the processor 104 may move to the next patch in the list as indicated at block 322. That is, the processor 104 may select a next patch in the list to process. In this regard, the processor 104 may implement blocks 306-322 on the next patch 410 until another sample point is determined at block 316 and stored at block 318. Additionally, at block 320, based on a determination that all of the patches in the list have been processed, e.g., that there are no additional patches in the list, the processor 104 may end the method 300 as indicated at block 324. The end of the method 300 may be the end of block 208 in the method 200.

Through implementation of the methods 200 and 300, the processor 104 may determine and store sample points corresponding to the surface of the NURBS model 400. In addition, as discussed above, the processor 104 or another processing device may interpolate the curves of the surface from the sample points, for instance, when the NURBS model is to be printed. According to examples, the determined sample points may require relatively less data than the NURBS model and thus, the determined sample points may be copied and/or manipulated relatively more easily than data corresponding to the NURBS model itself.

Some or all of the operations set forth in the methods 200 and 300 may be contained as utilities, programs, or subprograms, in any desired computer accessible medium. In addition, the methods 200 and 300 may be embodied by computer programs, which may exist in a variety of forms. For example, the methods 200 and 300 may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Reference is now made to FIG. 5, which depicts a NURBS model 500 that was directly sliced through implementation of the example methods depicted in FIGS. 2 and 3. Any example method that follows the above-described functions may correctly slice NURBS models whose weights are not necessarily equal to 1.0. In FIG. 5 the deepest visible point corresponds to a control point with weight set to 50. The mesh of control points of the NURBS model is 6 by 6, with one patch and parameter space: [0, 1]×[0, 1]. The control points with their weights listed as a fourth coordinate are: (−25,−25,−5,1), (−25,−15,0,1), (−25,−5,0,1), (−25,5,0,1), (−25,15,0,1), (−25,25,5,1), (−15,−25,0,1), (−15,−15,0,1), (−15,−5,0,1), (−15,5,0,1), (−15,15,1,1), (−15,25,1,1), (−5,−25,5,1), (−5,−15,5,1), (−5,−5,5,1), (−5,5,0,1), (−5,15,0,1), (−5,25,0,1), (5,−25,0,1), (5,−15,0,1), (5,−5,0,1), (5,5,−5,1), (5,15,−5,1), (5,25,−5,1), (15,−25,0,1), (15,−15,0,1), (15,−5,0,1), (15,5,0,1), (15,15,−10,50), (15,25,−10,1), (25,−25,0,1), (25,−15,0,1), (5,−5,0,1), (25,5,0,1), (25,15,0,1), (25,25,−5,1).

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor;
a memory on which are stored machine readable instructions that when executed by the processor, cause the processor to:
identify a slice height for direct slicing of a Non-Uniform Rational B-Spline (NURBS) model formed of surfaces by slicing planes;
slice the NURBS model to produce slices having the identified slice height, wherein a slicing plane of the slicing planes is provided between respective pairs of the slices;
adaptively subdivide surfaces of the NURBS model whose bounding boxes respectively intersect at least one of the slicing planes until the bounding boxes meet a predefined criterion;
for each of the generated bounding boxes which meet the predefined criterion, determine a sample point on the slice of the surface with which the bounding box intersects; and
store the determined sample points.

2. The apparatus of claim 1, wherein the NURBS model is in Euclidean space and wherein the instructions are further to cause the processor to map the NURBS model from Euclidean space to projective space and to adaptively subdivide the surfaces on the NURBS model in projective space.

3. The apparatus of claim 2, wherein the instructions are further to cause the processor to transform the determined sample points from projective space to Euclidean space and to output the determined sample points in Euclidean space.

4. The apparatus of claim 1, wherein the predefined criterion comprises at least one of a predefined height, a predefined width, or a predefined depth for the bounding boxes.

5. The apparatus of claim 1, wherein, to adaptively subdivide the surfaces, the instructions are further to cause the processor to:
identify a first bounding box that encompasses the surfaces of the NURBS model;
subdivide the surfaces in the first bounding box into a plurality of patches;
build a next bounding box for each of the plurality of patches; and
for each patch of the plurality of patches, subdivide the patch and build a next bounding box for the subdivided patch until dimensions of the next bounding box for the patch meet the predefined criterion.

6. The apparatus of claim 5, wherein the instructions are further to cause the processor to subdivide the surfaces into two or more patches and to subdivide the patches into two or more sub-patches.

7. The apparatus of claim 5, wherein the instructions are further to cause the processor to:
determine whether the next bounding boxes for the plurality of patches each intersects at least one of the slicing planes;
for each of the next bounding boxes that intersects at least one of the slicing planes, determine whether the next bounding box meets the predefined criterion; and
for each of the next bounding boxes that do not intersect at least one of the slicing planes, cease further processing of the next bounding box.

8. The apparatus of claim 1, wherein the instructions are further to cause the processor to identify centroids of the adaptively generated bounding boxes and to determine sample points of the surfaces as the identified centroids of the adaptively generated bounding boxes that meet the predefined criterion.

9. The apparatus of claim 1, wherein the instructions are further to cause the processor to one of aggregate the sampled points of the surfaces by connecting the sampled points to form a polygon or generate a plurality of curves from the sampled points of the surfaces.

10. A computer-implemented method comprising:
mapping, by the processor, a Non-Uniform Rational B-Spline (NURBS) model having surfaces into projective space;
identifying, by the processor, slices of the NURBS model, each of the slices abutting a slicing plane and having a slice height;
adaptively generating, by the processor, bounding boxes for respective surfaces of the NURBS model, the bounding boxes respectively including a portion of a surface of the NURBS model, intersecting at least one of the slicing planes, and meeting a predefined dimensional criterion;
for each of the adaptively generated bounding boxes that meet the predefined criterion, sampling, by the processor, points of the surface with which the bounding box corresponds; and
output, by the processor, the sampled points of the surfaces.

11. The computer-implemented method of claim 10, wherein adaptively generating the bounding boxes further comprises:
identifying a first bounding box that encompasses the surfaces of the NURBS model;
subdividing the surfaces in the first bounding box into a plurality of patches;
building a next bounding box for each of the plurality of patches; and
for each patch of the plurality of patches, subdividing the patch and building a next bounding box for the subdivided patch until dimensions of the next bounding box for the patch meet the predefined dimensional criterion.

12. The computer-implemented method of claim 11, further comprising:
determining whether the next bounding boxes for the plurality of patches and the subdivided patches each intersects at least one of the slicing planes;
for each of the next bounding boxes that intersects at least one of the slicing planes, determining whether the next bounding meets the predefined criterion; and
for each of the next bounding boxes that do not intersect at least one of the slicing planes, ceasing further processing of the next bounding box.

13. The computer-implemented method of claim 10, further comprising aggregating the sampled points of the surfaces by connecting the sampled points to form a polygon or a curve.

14. A non-transitory computer readable medium on which is stored machine readable instructions that when executed by a processor, cause the processor to:
map a Non-Uniform Rational B-Spline (NURBS) model having surfaces into projective space;
identify slices of the NURBS model, each of the slices abutting a slicing plane and having a slice height, the slices being orthogonal to a vertical axis of the NURBS model;
adaptively generate bounding boxes for respective surfaces of the NURBS model, the bounding boxes respectively including a portion of a surface of the NURBS model, intersecting at least one of the slicing planes, and meeting a predefined dimensional criteria;
for each of the adaptively generated bounding boxes that meet the predefined criterion, identify points of the surface with which the bounding box corresponds; and
output, by the processor, the identified points of the surfaces.

15. The non-transitory computer readable medium of claim 14, wherein the instructions are further to cause the processor to:
identify a first bounding box that encompasses the surfaces of the NURBS model;
subdivide the surfaces in the first bounding box into a plurality of patches;
build a next bounding box for each of the plurality of patches; and
for each patch of the plurality of patches, subdivide the patch and build the next bounding box for the subdivided patch until dimensions of the next bounding box for the patch meet the predefined dimensional criteria.
